(19) United States
(12) Patent Application Publication
(10) Pub. No.: US 2014/0013958 A1
(43) Pub. Date: Jan. 16, 2014

(54) HYBRID COFFEE MAKER WITH MULTIPLE BREWING MODES

(71) Applicant: SELECT BRANDS, INC., Lenexa, KS (US)

(72) Inventors: Mark T. Krasne, Kansas City, MO (US); William S. Endres, Leawood, KS (US); Blaise Wooderson, Olathe, KS (US)

(73) Assignee: SELECT BRANDS, INC., Lenexa, KS (US)

(21) Appl. No.: 13/782,898

(22) Filed: Mar. 1, 2013

Related U.S. Application Data
(60) Provisional application No. 61/670,876, filed on Jul. 12, 2012.

(51) Int. Cl. A47J 31/40

(52) U.S. Cl. CPC A47J 31/407
USPC 99/284

(57) ABSTRACT

A drink brewer is operable to hold brewable grounds in either an open filter or an enclosed capsule and brew a drink using the grounds. The drink brewer includes a water dispensing station and a brew basket structure. The water dispensing station includes a water nozzle to dispense water onto the grounds. The brew basket structure presents a brew chamber. The brew basket structure is shiftable between an open filter brewing configuration and a capsule brewing configuration.

### RELATED APPLICATION

This application claims the benefit of U.S. Provisional Application Ser. No. 61/670,876, filed Jul. 12, 2012, entitled COFFEE MAKER WITH SINGLE AND MULTIPLE SERVING BREWING MODES, which is hereby incorporated in its entirety by reference herein.

### BACKGROUND

1. Field

The present invention relates generally to a drink brewer. More specifically, embodiments of the present invention concern a hybrid coffee maker with multiple brewing modes.

2. Discussion of Prior Art

Prior art coffee makers take various forms and include conventional percolating coffee makers that generally include a carafe to brew multiple coffee servings at one time. Other prior art coffee makers include single-serving coffee makers that use coffee capsules to brew coffee.

However, prior art coffee makers suffer from various undesirable limitations. For example, conventional percolating coffee makers generally brew coffee using an open filter basket arrangement that is messy and requires excessive time to prepare, use, and clean up, particularly when used to brew a single serving of coffee. Conventional single-serving coffee makers are generally deficient when brewing multiple servings of coffee. For instance, brewing of multiple coffee servings generally requires multiple coffee capsules, which is expensive and results in undue waste.

### SUMMARY

The following brief summary is provided to indicate the nature of the subject matter disclosed herein. While certain aspects of the present invention are described below, the summary is not intended to limit the scope of the present invention.

Embodiments of the present invention provide a coffee maker that does not suffer from the problems and limitations of the prior art coffee makers set forth above.

A first aspect of the present invention concerns a drink brewer operable to contain brewable grounds and brew a drink using the grounds. The drink brewer broadly includes a water dispensing station and multiple shiftable station baskets. The water dispensing station includes a water nozzle to dispense water onto the grounds. The multiple shiftable station baskets present respective brew chambers. The brew chambers define chamber volumes different from each other, with the brew chambers operable to hold grounds and receive dispensed water on the grounds. The baskets are each selectively locatable in a brewing position where the brew chamber is aligned so as to be in fluid communication with the nozzle to hold grounds adjacent the nozzle. The water dispensing station presents a basket support structure that aligns and supports each of the baskets in the brewing position, with each of the baskets operable to be attached relative to the basket support structure in the brewing position.

A second aspect of the present invention concerns a drink brewer operable to hold brewable grounds in either an open filter or an enclosed capsule and brew a drink using the grounds. The drink brewer broadly includes a water dispensing station and a brew basket structure. The water dispensing station includes a water nozzle to dispense water onto the grounds. The brew basket structure presents a brew chamber. The brew basket structure is shiftable between an open filter brewing configuration where the brew basket structure supports the open filter with grounds during brewing and a capsule brewing configuration where the brew basket structure supports the enclosed capsule with grounds during brewing.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a right front perspective of a coffee brewing assembly constructed in accordance with a preferred embodiment of the present invention, with the coffee brewing assembly including a coffee brewer and a carafe;

FIG. 2 is a left front perspective of the coffee brewing assembly shown in FIG. 1, showing a brewer housing, a water reservoir, a dual brew basket, a shiftable nozzle assembly, and a user interface of the coffee brewer, with the reservoir and brew basket removed from the brewer housing, and a compartment door of the brewer housing pivoted open;

FIG. 3 is a right front perspective of the coffee brewer shown in FIGS. 1 and 2, showing a brewer housing base with a platform and a tray, with the tray being removed from the base platform so that a mug can be positioned on the platform;

FIG. 4 is a right front perspective of the coffee brewer similar to FIG. 3, but showing the tray returned to the platform and a cup positioned on the tray;

FIG. 5 is a fragmentary right front perspective of the coffee brewer shown in FIGS. 1-4, showing the nozzle assembly including a nozzle, plate, lever, and links that connect the plate and lever, and showing the dual brew basket with a basket body and a basket lid, with the nozzle assembly in a retracted position;

FIG. 6 is a fragmentary side elevation of the coffee brewer shown in FIGS. 1-5, showing the nozzle assembly and the dual brew basket, with the nozzle assembly in the retracted position;

FIG. 7 is a fragmentary right front perspective of the coffee brewer similar to FIG. 5, but showing the nozzle assembly shifted downwardly into an engaged position;

FIG. 8 is a fragmentary side elevation of the coffee brewer similar to FIG. 6, but showing the nozzle assembly shifted downwardly into the engaged position;

FIG. 9 is a fragmentary cross section of the coffee brewer shown in FIGS. 1-8, showing a water distribution head secured to the basket lid, with the nozzle assembly in the retracted position;

FIG. 10 is a fragmentary cross section of the coffee brewer similar to FIG. 9, but showing the nozzle assembly shifted downwardly into the engaged position, with the nozzle projecting into an inlet of the water distribution head, and with the coffee brewer in an open filter brewing configuration associated with an open filter brewing mode, but with an open top filter and grounds not being depicted;

FIG. 11 is a fragmentary cross section of the coffee brewer shown in FIGS. 1-10, showing a capsule brew basket secured to the basket lid, with the nozzle assembly in the retracted position;

FIG. 12 is a fragmentary cross section of the coffee brewer similar to FIG. 11, but showing the nozzle assembly shifted downwardly into the engaged position, with a needle of the nozzle piercing an upper wall of a coffee capsule, and with a needle of the capsule brew basket piercing a lower wall of the coffee capsule;

FIG. 13 is an exploded perspective of the dual brew basket and water distribution head shown in FIGS. 9 and 10, showing the basket lid exploded from the basket body, the fractional-turn connection arrangement between the basket lid and basket body, and the fractional-turn connection arrangement between the basket lid and the water distribution head;

FIG. 14 is a cross section of the dual brew basket and water distribution head shown in FIGS. 9, 10, and 13, and showing the open top filter and grounds depicted schematically;

FIG. 15 is an exploded perspective of the dual brew basket, capsule brew basket, and coffee capsule shown in FIGS. 11 and 12, showing the basket lid exploded from the basket body, the fractional-turn connection arrangement between the basket lid and basket body, and the fractional-turn connection arrangement between the basket lid and the capsule brew basket;

FIG. 16 is a cross section of the dual brew basket, capsule brew basket, and coffee capsule shown in FIGS. 11, 12, and 15; and

FIG. 17 is a schematic view of the coffee brewing assembly shown in FIGS. 1-16, showing the water reservoir, pump, boiler, and nozzle assembly in fluid communication with one another, with the nozzle assembly being in fluid communication with either the coffee capsule in the capsule brewing configuration or the open basket filter with grounds in the open filter brewing configuration, and showing electrical communication between the user interface, controller, thermostat, pump, and boiler.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

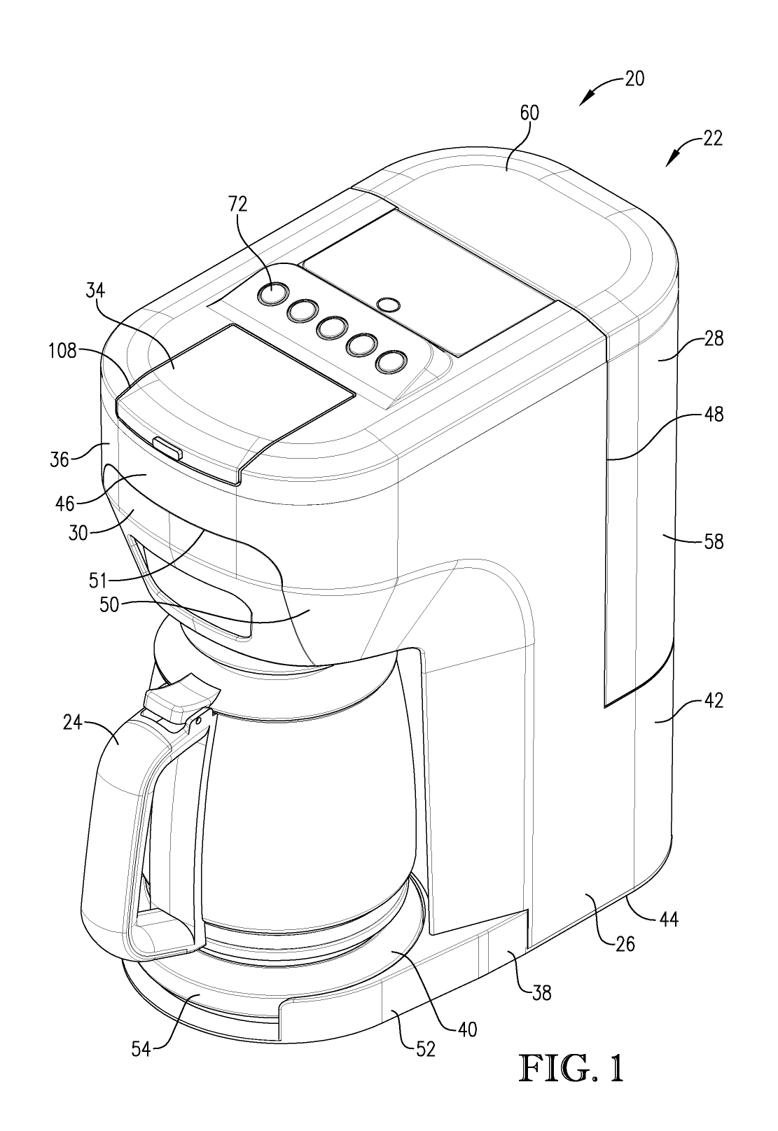

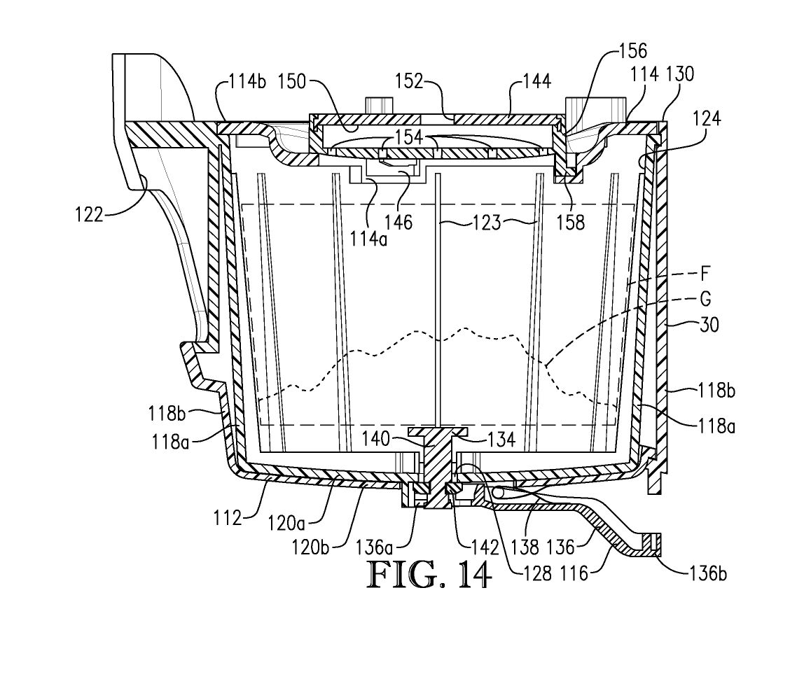

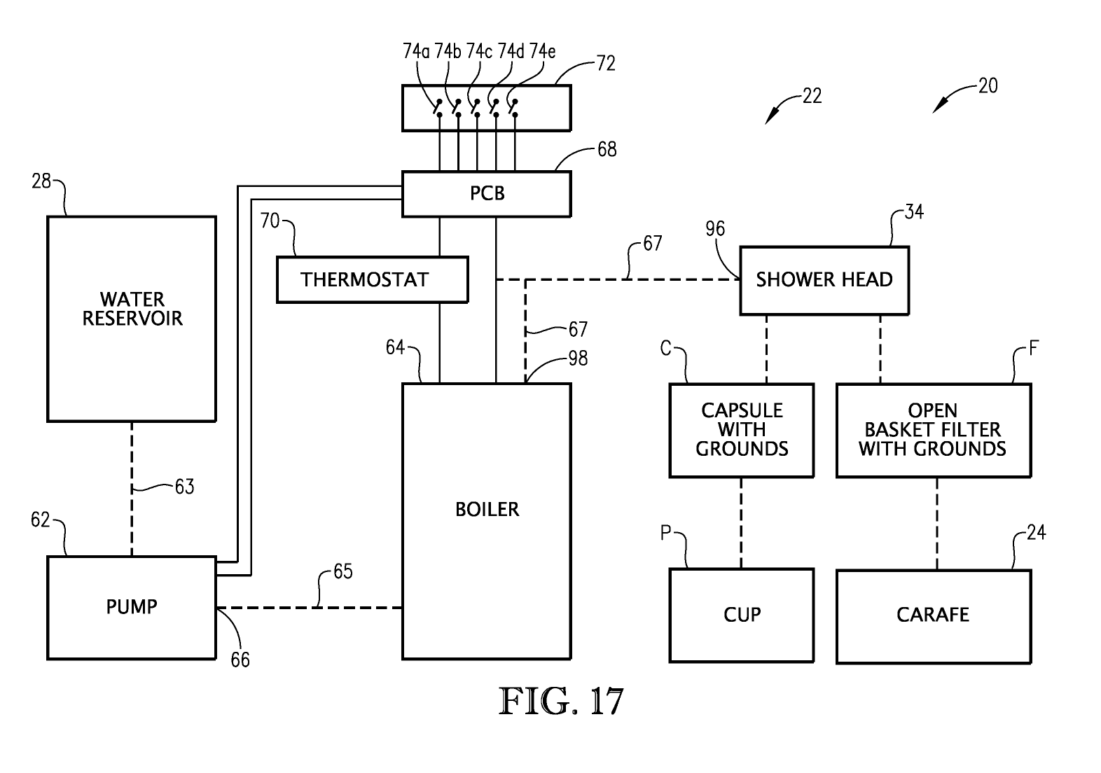

Turning initially to FIGS. 1-4, a hybrid coffee brewing assembly 20 is constructed in accordance with a preferred embodiment of the present invention. The brewing assembly 20 is designed to operate in an open filter serving mode where one or more servings of coffee are brewed from exposed coffee grounds G contained by a conventional open filter F, such as a disposable paper basket filter or a reusable screen basket filter (see FIGS. 14 and 17). That is, the grounds G are contained in an open filter brewing configuration. In this configuration, the water is generally dispensed onto the grounds at ambient pressure, with water flowing through the grounds G generally in response to gravity.

The brewing assembly 20 is also designed to operate in a capsule serving mode where one or more servings of coffee are brewed from an enclosed capsule containing a filter (not shown) and coffee grounds (not shown). That is, the grounds are contained in a capsule brewing configuration. In this configuration, the water is generally dispensed onto the grounds at an elevated pressure (i.e., a pressure above ambient), with the water flow through the grounds being generally pressurized. However, this configuration could be associated with water flow dispensed at ambient pressure.

The illustrated brewing assembly 20 is preferably used to brew coffee. However, the principles of the present invention are applicable where the brewing assembly 20 is used to brew tea, espresso, hot chocolate, or other brewed drinks. The illustrated brewing assembly 20 broadly includes a coffee brewer 22 and a carafe 24.

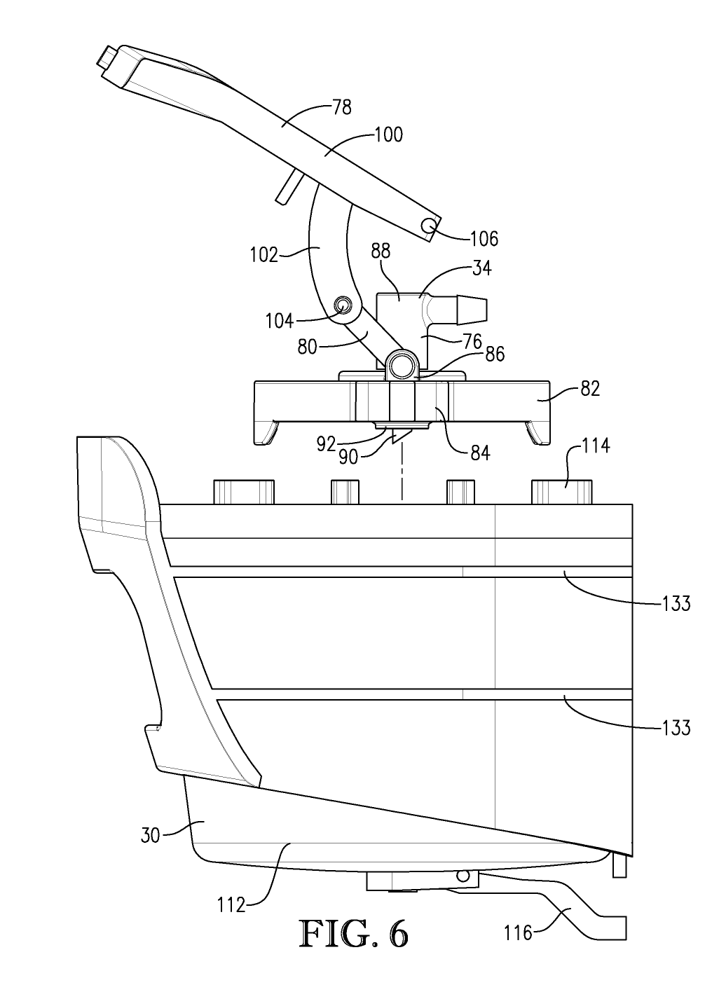

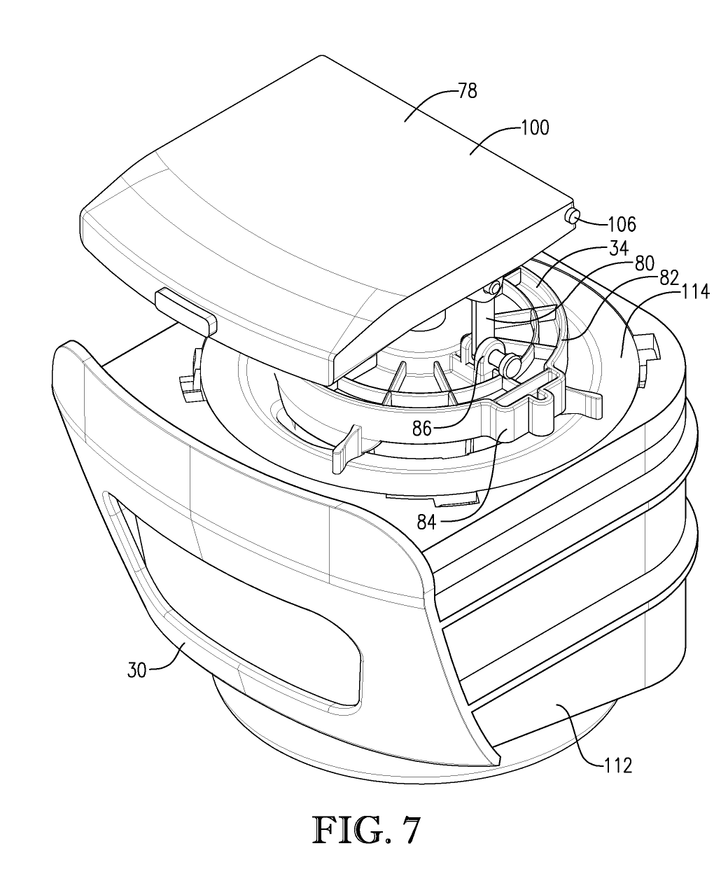

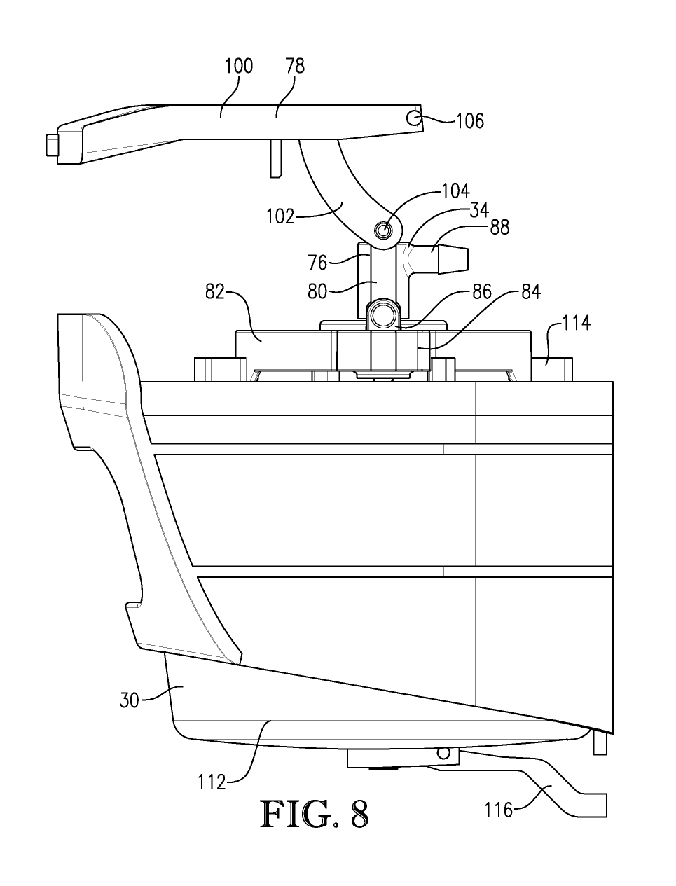

Turning to FIGS. 1-8, the coffee brewer 22 includes, among other things, a brewer housing 26, water reservoir 28, dual brew basket 30, capsule brew basket 32, and a nozzle assembly 34. As will be discussed, the coffee brewer 22 provides a water dispensing station 36 that works with the illustrated dual and capsule brew baskets 30,32 to brew coffee.

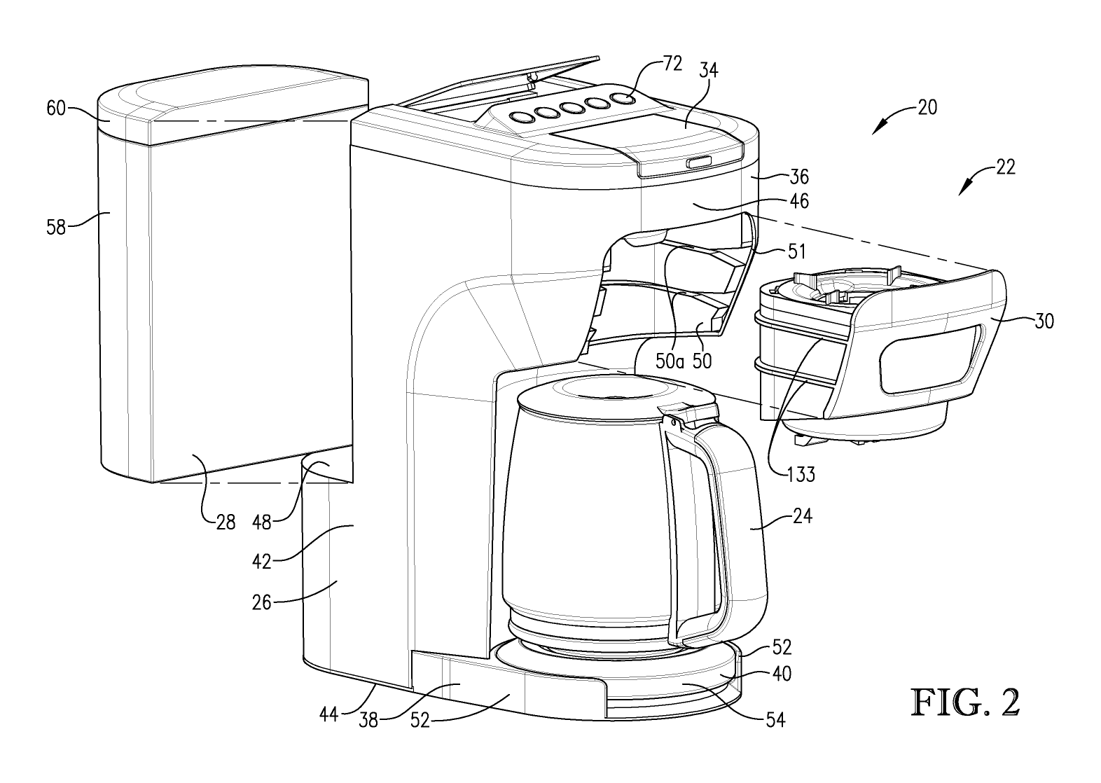

The brewer housing 26 preferably includes a base 38, a tray 40, and a body 42. The body 42 is elongated and presents a lower end 44 and an overhanging section 46. The body 42 also presents a rear opening 48 operable to receive the reservoir 28. As will be discussed, the overhanging section 46 presents a basket support structure 50 that defines a basket opening 51. The basket support structure 50 preferably presents lateral grooves 50a that receive corresponding ribs of the dual brew basket 30 (see FIG. 2).

The base 38 includes a platform and a raised wall margin 52 that partly extends around the platform. The base 38 is fixed to the lower end 44 of the body 42 and serves to stabilize the brewer housing 26.

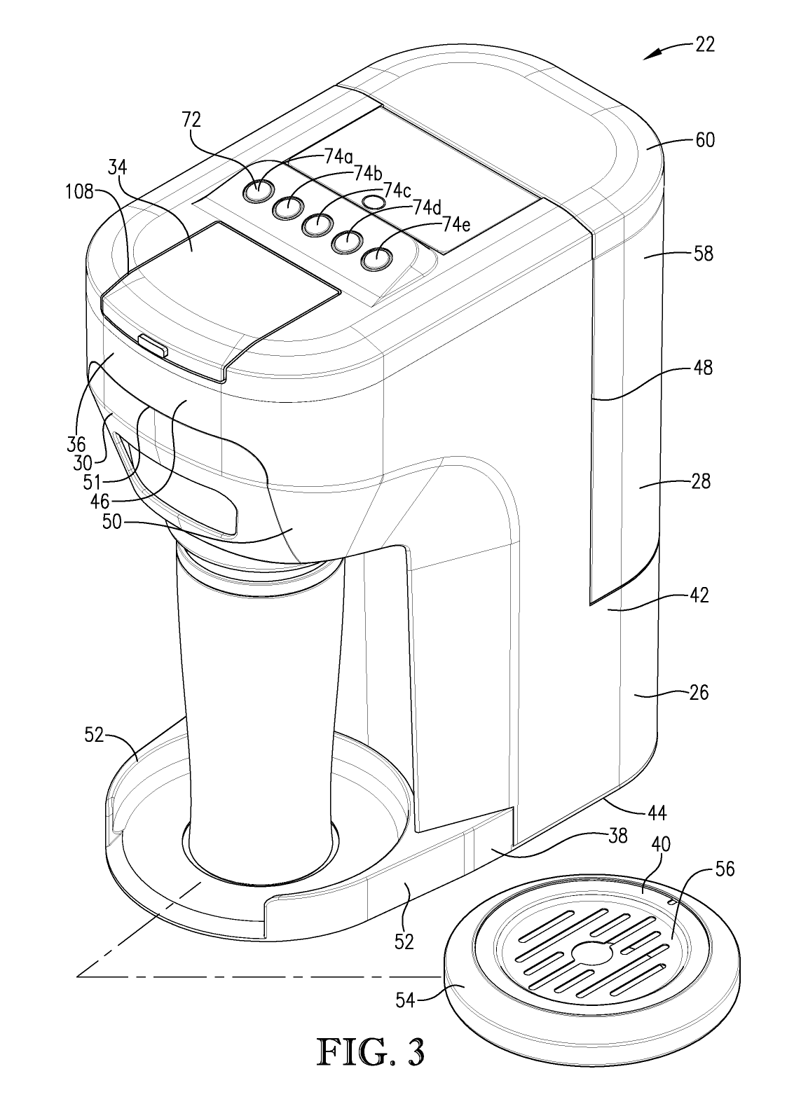

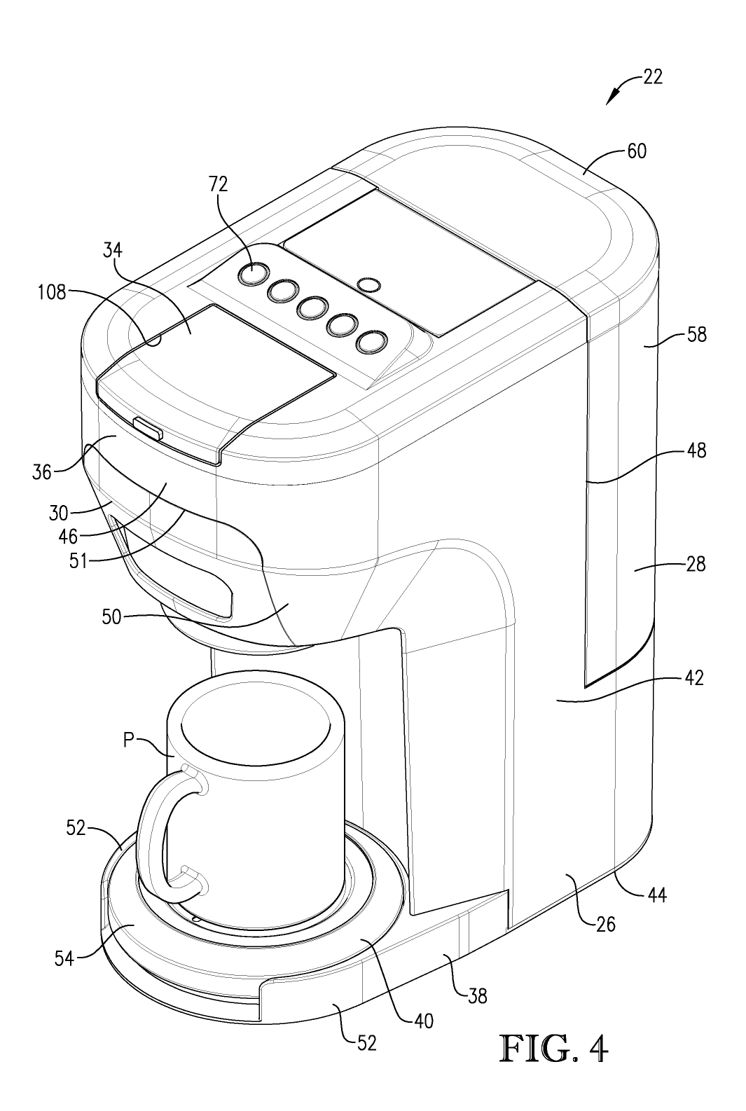

The tray 40 has a generally hollow base 54 to catch spilled liquid and a grill 56 mounted in an opening of the base 54 (see FIG. 3). The tray 40 is usable on the platform to accommodate the use of the carafe 24 or a relative short coffee cup P (see FIG. 4). However, the tray 40 can be removed from the platform to accommodate the use of a relatively tall coffee mug M (see FIG. 3). The tray 40 can also be attached to the body 42 at a location spaced above the platform (e.g., when brewing a single serving of coffee in the coffee cup P).

The illustrated base 38 and tray 40 preferably do not include a heating element to heat the carafe 24. However, it is within the ambit of the present invention where the base 54 or tray 40 includes such a heating element (e.g., to maintain the coffee in the carafe 24 at an elevated temperature).

The reservoir 28 is operable to hold water for brewing and includes a reservoir container 58 and a reservoir lid 60 removably mounted on the open top of the container 58. The reservoir 28 also presents a lower attachment end that permits the reservoir 28 to be removably mounted in the opening 48. When attached, the reservoir 28 is in fluid communication with a pump 62 via a water line 63 (see FIG. 17).

The attachment end of the reservoir 28 includes a normally-closed valve (not shown), and the body 42 includes a connector (not shown). The valve and connector are fluidly connected when the reservoir 28 is attached to permit fluid flow from the reservoir 28 to the pump 62. In particular, connection of the connector and the valve causes the valve to open so as to permit fluid flow. The valve and connector are detachable from each other when the reservoir 28 is removed. Detachment causes the valve to return to the normally closed position so that water contained in the reservoir 28 is restricted from spilling out of the valve. While the illustrated coffee brewer 22 preferably includes the reservoir 28, the principles of the present invention are applicable where the coffee brewer 22 does not have a reservoir (e.g., where the coffee brewer 22 is directly connected to a water supply line).

Turning to FIG. 17, the coffee brewer 22 also preferably includes the pump 62 and a boiler 64. The pump 62 and boiler 64 are conventional and are mounted within the brewer housing 26. The boiler 64 is preferably in fluid communication via a water line 65 with a discharge 66 of the pump 62. The boiler 64 also is in fluid communication with the nozzle assembly 34 via a water line 67. Thus, the pump 62 preferably draws water from the reservoir 28 and pumps the water through the boiler 64 and toward the nozzle assembly 34. However, it is within the scope of the present invention where an alternative arrangement is used to pump and heat the water. For instance, the boiler 64 could be fluidly connected between the pump 62 and reservoir 28. Also, for some aspects of the invention, the coffee brewer 22 could include a conventional water percolation system to provide heated water to the nozzle assembly 34, with the percolation system including a heating element and a one-way valve.

The coffee brewer 22 also preferably includes a controller 68, a thermostat 70, and a user interface 72. The controller 68 is preferably a conventional printed circuit board operably coupled to the boiler 64 and the pump 62. The thermostat 70 is operably coupled to the boiler 64 to sense the water temperature within the boiler 64 and to the controller 68. The user interface 72 includes a plurality of switches 74a,b,c,d,e operably coupled to the controller 68 (see FIGS. 3 and 17). Activation of switch 74a causes the coffee brewer 22 (including the controller 68) to be powered on.

The controller 68 is operably coupled to the pump 62 to control the amount of time the pump 62 is operated. The illustrated switches 74c,d,e work with the controller 68 to provide corresponding water pumping cycles, with each water pumping cycle having a preset run time for the pump 62, associated with the capsule brewing mode of the coffee brewer 22. For instance, activation of the switches 74c,d,e preferably causes the controller 68 to operate the pump 62 to direct, respectively, about six (6) ounces of water, about eight (8) ounces of water, and about ten (10) ounces of water to the nozzle assembly 34.

Activation of the switch 74b causes the controller 68 to operate the pump 62 in an open filter brewing mode of the coffee brewer 22 where the pump 62 preferably directs about ten (10) cups of water to the nozzle assembly 34 during multiple water pumping cycles. Preferably, activation of the switch 74b causes the pump 62 to direct water in three separate water pumping cycles, with each cycle lasting about ninety (90) seconds, as discussed below. It will be appreciated that the illustrated controller 68 and user interface 72 could be alternatively configured to provide alternative pump run times (e.g., so that the pump 62 provides alternative amounts of water in the open filter brewing mode and/or the capsule brewing mode).

The controller 68 also operates to control the boiler 64 to provide water to the nozzle assembly 34 at a predetermined temperature. In particular, the boiler 64 is preferably used to preheat water during a water heating cycle prior to the water being pumped to the nozzle assembly 34. For the capsule brewing mode, the water heating cycle preferably runs from about twenty (20) seconds to about forty (40) seconds.

For the open filter brewing mode, the water heating cycle preferably runs multiple times. For each water heating cycle, the boiler 64 runs preferably for about thirty (30) seconds. To provide about ten (10) cups of heated water in the open filter brewing mode, the coffee brewer 22 preferably alternates between the water heating cycle and the water pumping cycle. More preferably, the open filter brewing mode begins with a thirty (30) second water heating cycle followed by a ninety (90) second water pumping cycle, with each water pumping cycle directing about three and one-third (3⅓) cups of water to the nozzle assembly 34. This combination of cycles is then preferably repeated twice so that each of three water heating cycles is followed by a corresponding water pumping cycle.

Again, the cycles could be alternatively configured to provide an alternative amount of water and/or water temperature to the nozzle assembly 34. For instance, the open filter brewing mode could include an alternative number and/or length of water heating cycles. The open filter brewing mode could also include an alternative number and/or length of water pumping cycles. Yet further, the water heating and water brewing cycles could be alternatively ordered to provide a flow of water suitable for brewing coffee.

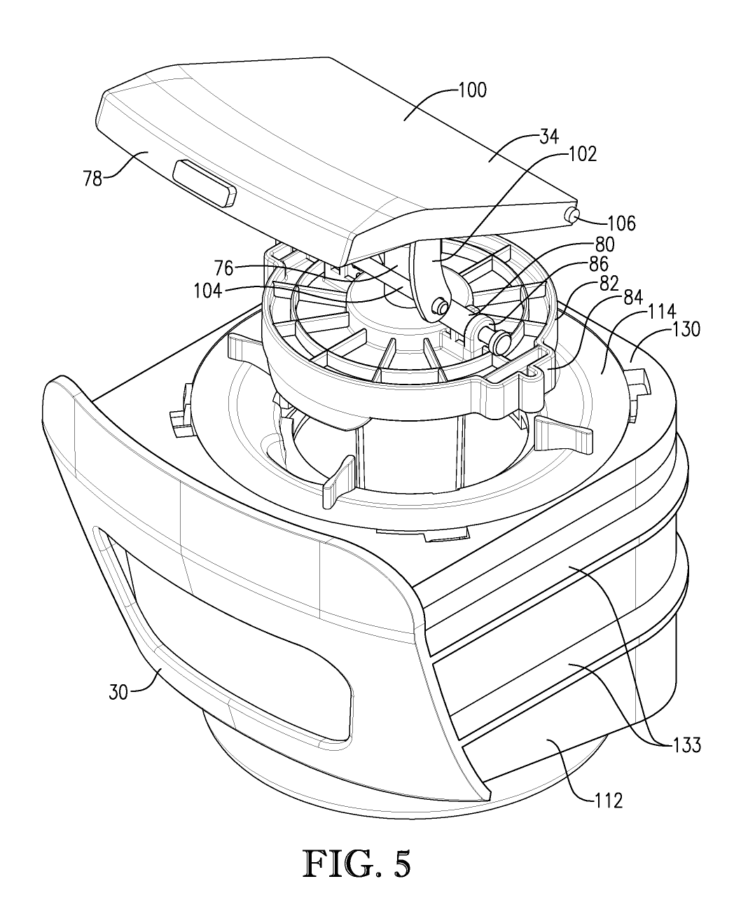

Turning to FIGS. 5-12, the nozzle assembly 34 includes a nozzle 76, lever 78, links 80, and a plate 82. The plate 82 comprises a unitary disc-shaped member that presents opposite lateral guides 84 and tabs 86. The plate 82 is slidably mounted within the brewer housing 26. In particular, the guides 84 are received in upright grooves (not shown) so that the plate 82 translates vertically between engaged and retracted nozzle positions. As will be discussed, the engaged nozzle position is associated with activation of the coffee brewer 22 in either the capsule brewing mode or the open filter brewing mode.

The nozzle 76 preferably includes an elbow 88, a needle 90 secured to the elbow 88, and a grommet 92. The needle 90 extends through an opening 94 in the plate 82 and is secured to the plate 82 with the grommet 92, with an exposed end of the needle 90 spaced below the plate 82. The elbow 88 is in fluid communication with the water line 67 running between an inlet 96 of the elbow 88 to an outlet 98 of the boiler 64 (see FIG. 17).

The lever 78 is unitary and includes a body 100, a pair of arms 102 attached to the body 100, and a shaft 104. The body 100 includes a pivot end 106 that is attached to the brewer housing 26 at a lever opening 108. The body 100 is pivotal between a lower position, where the body 100 substantially covers the opening 108, and an upper position, where the body 100 projects above the opening 108.

The lever 78 is connected to the arms 102 with the pair of links 80 attached to the shaft 104 and to the tabs 86. Thus, when the lever 78 is pivoted into the lower position, the links 80 move the plate 82 and needle 90 into the engaged nozzle position. When the lever 78 is pivoted into the upper position, the links 80 move the plate 82 and needle 90 into the retracted nozzle position.

Additional preferred features of the nozzle assembly 34 and operation thereof are described in U.S. Patent Publication No. 20110271843, published Nov. 10, 2011, entitled EXTRACTING MECHANISM FOR COFFEE CAPSULE, which is hereby incorporated in its entirety by reference herein.

In the engaged nozzle position, the nozzle 76 is preferably shifted to a position adjacent the open top of the dual brew basket 30. However, it is within the scope of the present invention where the nozzle 76 is alternatively located. For instance, the nozzle 76 could be positioned at least partly in the brew chamber of the dual brew basket 30 in the engaged nozzle position. Also, the nozzle assembly 34 could be constructed to provide different engaged nozzle positions where each position is associated with one of the open filter and capsule brewing configurations.

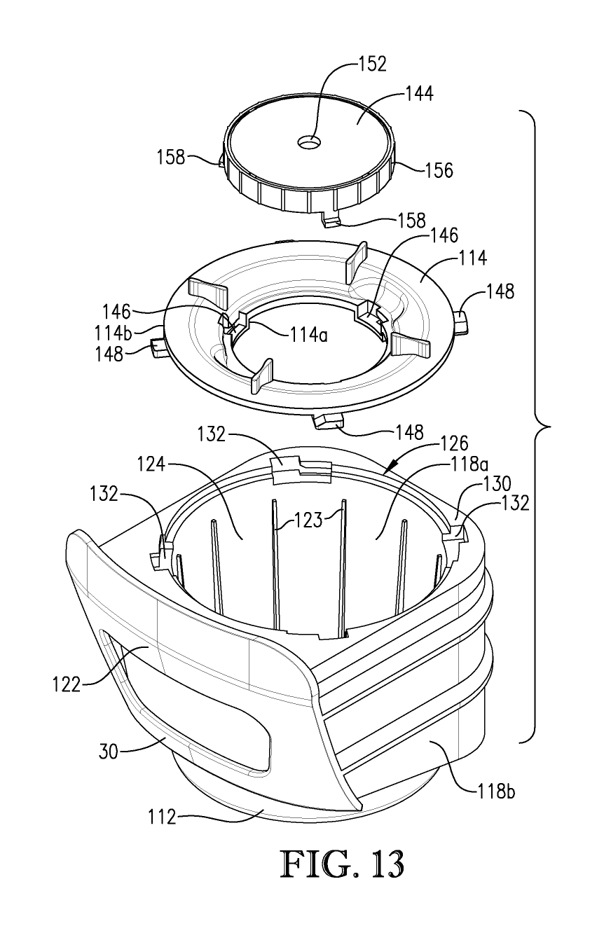

Turning to FIGS. 5-16, the coffee brewer 22 provides a water dispensing station 36 that works with the illustrated dual and capsule brew baskets 30,32 to brew coffee. The dual brew basket 30 preferably includes a basket body 112, a basket lid 114, and a drain valve assembly 116 (see FIGS. 13 and 14). The basket body 112 preferably includes inner and outer side walls 118a,b, inner and outer bottom walls 120a,b, and a handle 122 attached to the outer side wall 118b (see FIG. 14). The inner side wall 118a and inner bottom wall 120a preferably cooperatively present a series of upright, circumferentially spaced ribs 123.

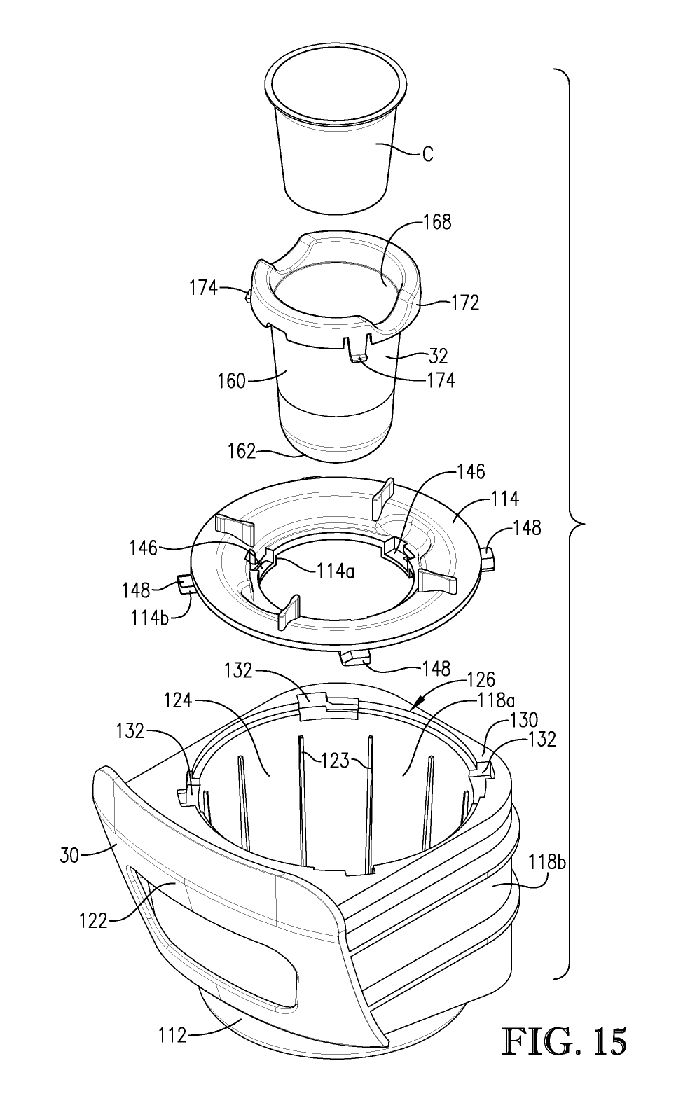

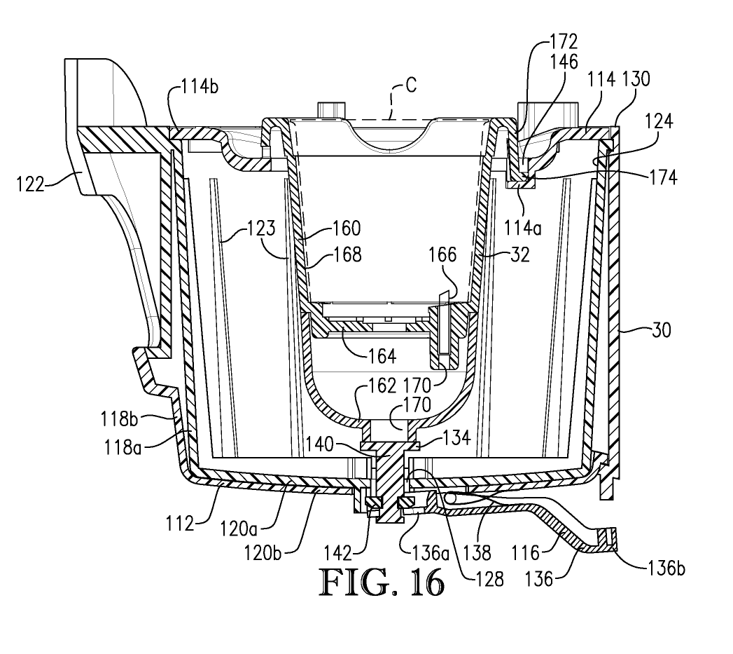

The inner side wall 118a and inner bottom wall 120a cooperatively define a brew chamber 124 and an open basket top 126 (see FIGS. 13 and 15). The bottom walls 120 cooperatively define a drain opening 128 (see FIGS. 14 and 16). The drain opening 128 fluidly communicates with the brew chamber 124 so that fluid can be drained from the brew chamber 124.

The side walls 118 cooperatively define an upper connection margin 130 that presents circumferentially spaced connector sockets 132 (see FIGS. 13-16). Thus, the upper connection margin 130 preferably forms a fractional-turn connector that engages the basket lid 114, as will be discussed. The outer side wall 118b preferably presents laterally extending ribs 133 that engage corresponding grooves 50a so that the dual brew basket 30 can be slid into and out of the basket opening 51 (see FIG. 2).

Turning to FIGS. 14 and 16, the drain valve assembly 116 preferably is used to open and close the drain opening 128. The drain valve assembly 116 preferably includes a drain plug 134, a lever 136, and a spring 138. The illustrated drain plug 134 includes a body 140 and a seal 142 mounted on the body 140. The body 140 of the drain plug 134 extends into and out of the drain opening 128, with an upper end of the drain plug 134 spaced above the inner bottom wall 120a. The drain plug 134 is shiftable into and out of a closing position where the drain plug 134 prevents fluid flow through the drain opening 128.

The lever 136 presents opposite inboard and outboard ends 136a,b and is pivotally mounted to the outer bottom wall 120b at a location between the ends 136a,b. The inboard end 136a is attached to the drain plug 134 so that pivoting of the lever 136 causes corresponding plug movement. The spring 138 is preferably mounted in engagement with the lever 136 and the outer bottom wall 120b so that the spring 138 urges the lever 136 and drain plug 134 into the closing position so that the drain plug 134 is spring-biased upwardly into the closing position.

When the carafe 24 is placed onto the tray 40, part of the carafe 24 preferably engages the lever 136 adjacent the outboard end 136b so that the drain plug 134 is shifted out of the closing position. When the carafe 24 is removed from the tray 40, the drain valve assembly 116 preferably automatically returns the drain plug 134 to the closing position to restrict fluid from draining out of the brew chamber 124.

While the drain plug 134 provides a preferred drain valve arrangement, the principles of the present invention are applicable where the drain valve assembly 34 is alternatively configured.

Turning again to FIGS. 13-16, the basket lid 114 is operable to support the capsule brew basket 32 or a water distribution head 144 during brewing. The basket lid 114 preferably comprises a unitary annular body that presents radially inner and outer connection margins 114a,b. The inner connection margin 114a presents a central opening and circumferentially spaced connector sockets 146. Thus, the inner connection margin 114a preferably forms an inner fractional-turn connector. As will be discussed, the inner fractional-turn connector can be selectively connected to either the water distribution head 144 or the capsule brew basket 32.

The outer connection margin 114b presents circumferentially spaced connector tabs 148 so that the outer connection margin 114b preferably forms an outer fractional-turn connector. The outer fractional-turn connector of the basket lid 114 is preferably removably attachable to the upper connection margin 130 of the basket body 112 by inserting the connector tabs 148 into respective sockets 132 and turning the lid 114 clockwise relative to the basket body 112 a fraction of a full turn.

It will be appreciated that an alternative connector arrangement could be used to connect the basket lid 114 and the basket body 112 without departing from the scope of the present invention. Furthermore, the basket lid 114 could be fixed to the basket body 112.

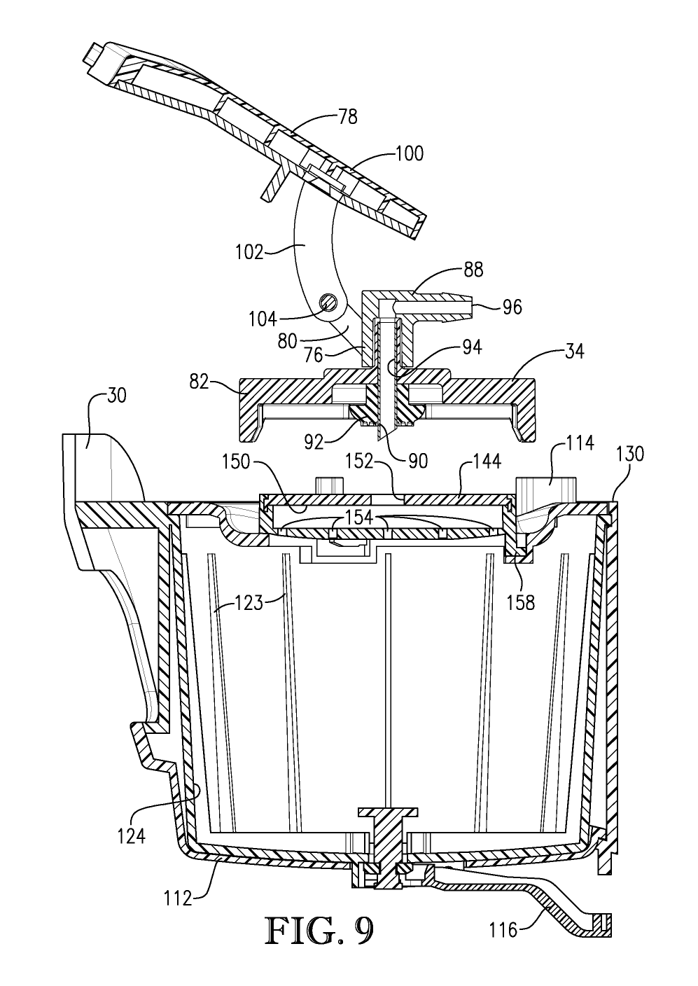

Turning to FIGS. 9, 10, 13, and 14, the coffee brewer 22 also preferably includes the water distribution head 144. The head 144 is preferably used when the coffee brewer 22 is in the open filter brewing configuration.

The head 144 preferably comprises a unitary disc that presents a chamber 150, an inlet 152 on one side of the disc, and multiple outlets 154 on the other side of the disc. The head 144 also preferably includes an outboard connection margin 156 that presents circumferentially spaced connector tabs 158 so that the outboard connection margin 156 preferably forms an outer fractional-turn connector. The outer fractional-turn connector of the head 144 is preferably removably attachable to the inner connection margin 114a of the basket lid 114 by inserting the connector tabs 158 into respective sockets 146 and turning the head 144 clockwise relative to the basket lid 114 a fraction of a full turn. However, it will be appreciated that an alternative connector arrangement could be used to connect the basket lid 114 and the head 144 without departing from the scope of the present invention.

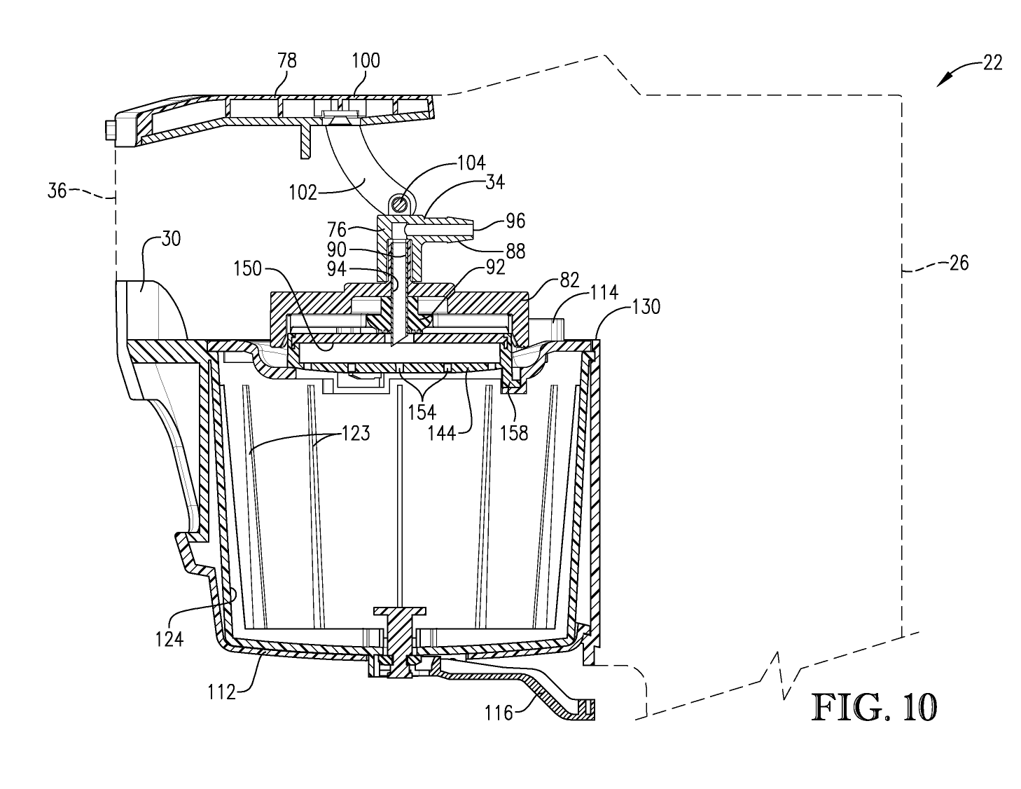

When the head 144 is installed and the nozzle assembly 34 is in the engaged nozzle position, the inlet 152 receives the needle 90 of the nozzle assembly 34 (see FIG. 10). In this position, the nozzle 76 fluidly communicates with the chamber 150 so that water flow into the head 144 is distributed by the head 144 and the distributed water flow is discharged into the brew chamber 124. It has been found that this combination is particularly effective for using the nozzle assembly 34 in the open filter brewing configuration. However, it is within the ambit of the present invention where the head 144 is alternatively configured. Also, for some aspects of the present invention, the coffee brewer 22 could be devoid of the head 144 such that the nozzle 76 discharges water directly into the brew chamber 124.

The open filter brewing configuration is preferably associated with the open filter brew mode discussed above. Thus, in the open filter brewing configuration, the coffee brewer 22 preferably runs through the described series of heating and pumping cycles.

It has been found that the open filter brewing configuration and the open filter brew mode cooperatively permit the illustrated coffee brewer 22 to perform open filter brewing of coffee grounds. For instance, the coffee brewer 22 is able to utilize the illustrated pump and boiler arrangement without pumping water too quickly into the dual brew basket 30. However, the principles of the present invention are also applicable where the open filter brewing configuration is used in connection with an alternative arrangement and/or configuration of water heating and pumping cycles. For instance, the open filter brewing configuration could be used to distribute a flow of water provided by a single continuous pumping cycle (e.g., where the single cycle water flow is provided at a relatively lower pressure and/or lower flow rate compared to the water flow provided by the open filter brew mode).

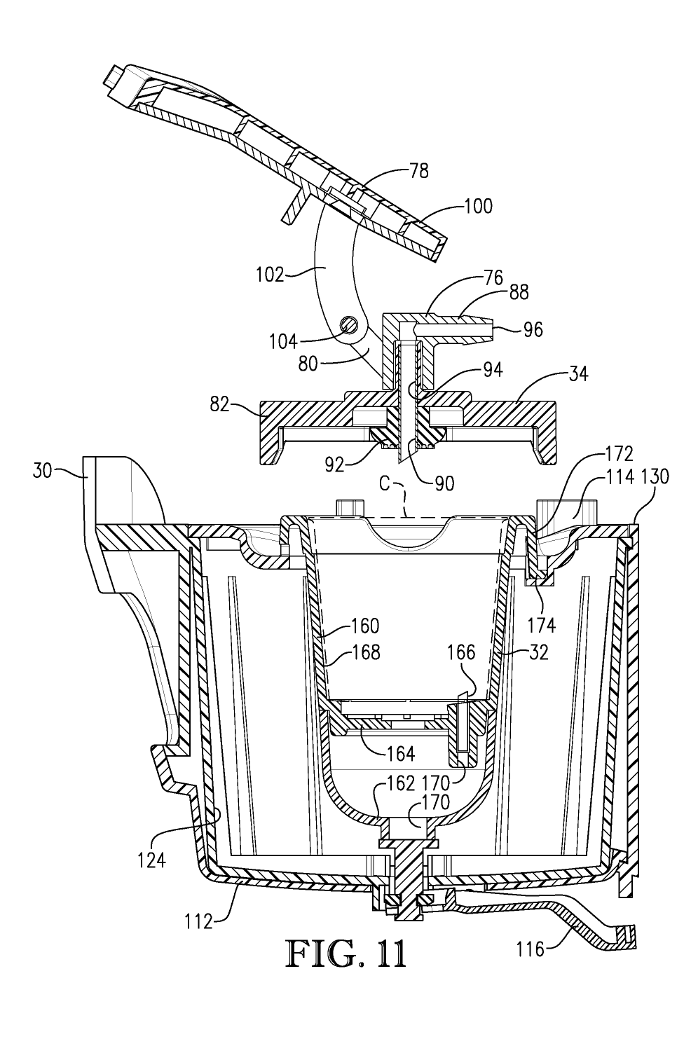

Turning to FIGS. 11, 12, 15, and 16, the capsule brew basket 32 is preferably used in the capsule brewing configuration to brew grounds contained in a sealed enclosed capsule C. The capsule brew basket 32 preferably includes a side wall 160, a bottom wall 162, an intermediate wall 164, and a needle 166.

The side wall 160 and bottom wall 162 cooperatively define a capsule brew chamber 168 and an open top. The bottom and intermediate walls 162,164 define respective drain openings 170 that fluidly communicate with the capsule brew chamber 168 so that fluid can be drained from the capsule brew chamber 168.

The side wall 160 defines an upper capsule connection margin 172 that presents circumferentially spaced connector tabs 174. Thus, the upper capsule connection margin 174 preferably forms an outer fractional-turn connector that engages the basket lid 114.

The outer fractional-turn connector of the capsule brew basket 32 is preferably removably attachable to the inner connection margin 114a of the basket lid 114 by inserting the connector tabs 174 into respective sockets 146 and turning the capsule brew basket 32 clockwise relative to the basket lid 114 a fraction of a full turn. However, it will be appreciated that an alternative connector arrangement could be used to connect the basket lid 114 and the capsule brew basket 32 without departing from the scope of the present invention.

Thus, the illustrated capsule brew basket 32 is preferably supported by the basket body 112 and basket lid 114 so that the capsule brew basket 32 is positioned within the brew chamber 124 (see FIG. 11). In other words, the dual brew basket 30 preferably supports the capsule brew basket 32 relative to the brewer housing 26. However, it is within the ambit of the present invention where the capsule brew basket 32 is alternatively supported. For instance, the capsule brew basket 32 could be constructed to attach directly to the brewer housing 26 without using the dual brew basket 30.

When the capsule brew basket 32 is installed within the brew chamber 124, the bottom wall 162 preferably extends down into contact with the drain plug 134, with the drain plug presenting openings (not shown) that permit fluid to flow through the lowermost drain opening and into the chamber 124. Also, the bottom wall 162 of the installed capsule brew basket 32 shifts the drain plug 134 downwardly out of the closed position so that the drain opening 128 permits fluid flow out of the brew chamber 124. Importantly, the capsule brew basket 32 is secured to the basket lid 114 so that the capsule brew basket 32 overcomes the upward force applied to the drain plug 134 by the spring 138. In this manner, the capsule brew basket 32 preferably disengages the normally-closed valve assembly 116.

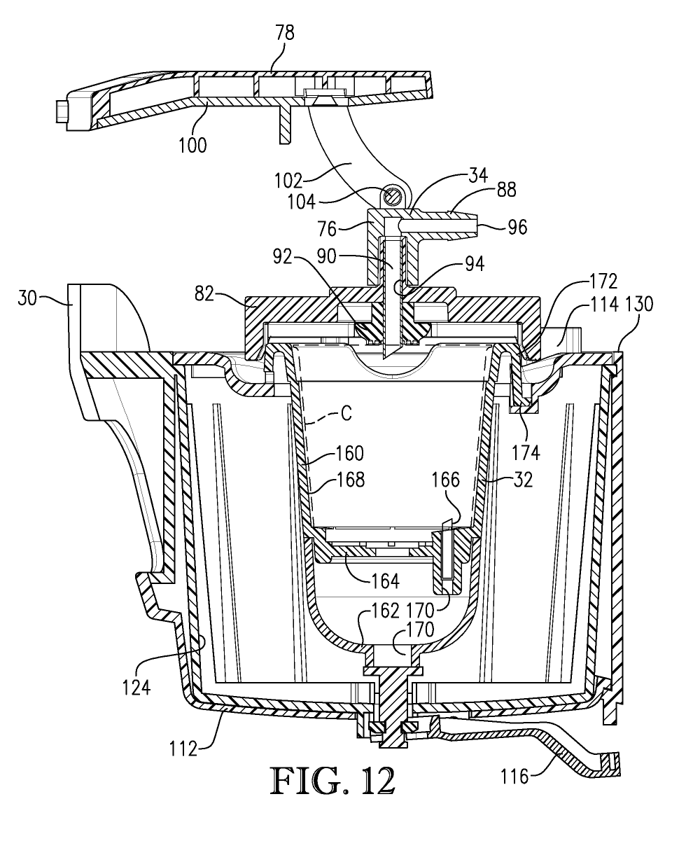

When the capsule brew basket 32 is installed and the nozzle assembly 34 is disengaged, the capsule C can be inserted into the capsule brew chamber 168. The nozzle assembly 34 can then be shifted to the engaged nozzle position so that the needle 90 of the nozzle assembly 34 punctures the top of the capsule C, with the needle 166 of the capsule brew basket 32 puncturing the bottom of the capsule C (see FIG. 12). In this position, the nozzle 76 fluidly communicates with the capsule C and the brew chamber 124 so that water flows through the capsule C and into the brew chamber 124.

The capsule brewing configuration is preferably associated with the capsule brew mode discussed above. Thus, in the capsule brewing configuration, the coffee brewer 22 preferably runs through a heating cycle and one of the three pumping cycles associated with brewing six (6), eight (8), or ten (10) ounces of water.

The illustrated coffee brewer 22 preferably includes both brew baskets 30,32 to provide the open filter brewing configuration and the capsule brewing configuration. However, it is within the ambit of the present invention where an alternative brew basket is used to provide the open filter and capsule brewing configurations. In one alternative, a single brew basket could be constructed to present a single chamber that supports an open filter arrangement and to also support an enclosed capsule for brewing. This alternative could be provided by the brew basket having a frame element that supports a capsule and is removably mounted in the brew chamber (e.g., in a location spaced below the open top of the brew basket). The brew basket could also have an adjustable structure that is shiftably mounted within the brew chamber to a wall of the brew basket. Also, the single brew basket could be designed so that the bottom wall directly supports the capsule C (e.g., where the nozzle can be shifted downwardly into the brew chamber).

In operation, the coffee brewer 22 is turned on by activating the switch 74a. The user can configure the coffee brewer 22 in the open filter brewing configuration by inserting an open filter with grounds into the brew chamber 124 of dual brew basket 30. Also, the basket lid 114 and head 144 are attached to the basket body 112. The dual brew basket 30 is then shifted onto the brewer housing 26 and the nozzle assembly 34 is shifted downwardly into the engaged nozzle position so that the nozzle is located above the grounds and in fluid communication with the brew chamber 124.

A container, such as the carafe 24 is then placed on the tray 40 below the dual brew basket 30 so that the dual brew basket 30 engages the drain valve assembly 116 and the carafe is in fluid communication with the drain opening 128. If necessary, the user can add water to the reservoir 28. The user can then begin brewing coffee by activating the switch 74b so that the controller 68 begins the heating and pumping cycles associated with the open filter brewing mode.

The user can also configure the coffee brewer 22 in the capsule brewing configuration by inserting an enclosed capsule C with grounds into the brew chamber 124. In particular, the basket lid 114 and capsule brew basket 32 are attached to the dual brew basket 30 so that the capsule brew basket 32 is mounted in the brew chamber 124. At the same time, the capsule brew basket 32 engages the drain plug 134 and shifts the drain plug 134 open so that the drain opening 128 permits water flow out of the brew chamber 124. The capsule C is then positioned within the capsule brew chamber 168. The brew baskets 30,32 are then shifted onto the brewer housing 26 and the nozzle assembly 34 is shifted downwardly into the engaged nozzle position so that the needles 90,166 pierce upper and lower walls of the capsule C, with the nozzle thereby fluidly communicating with the grounds and the brew chamber 124.

A container, such as the carafe 24, the mug, or the cup is then placed below the dual brew basket 30 and the container is in fluid communication with the drain opening 128. If necessary, the user can add water to the reservoir 28. The user can then begin brewing coffee by activating one of the switches 74c,d,e so that the controller 68 begins the heating and pumping cycle associated with the capsule brewing mode.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A drink brewer operable to contain brewable grounds and brew a drink using the grounds, said drink brewer comprising:
a water dispensing station that includes a water nozzle to dispense water onto the grounds; and
multiple shiftable station baskets presenting respective brew chambers,
said brew chambers defining chamber volumes different from each other, with the brew chambers operable to hold grounds and receive dispensed water on the grounds,
said baskets each selectively locatable in a brewing position where the brew chamber is aligned so as to be in fluid communication with the nozzle to hold grounds adjacent the nozzle,
said water dispensing station presenting a basket support structure that aligns and supports each of the baskets in the brewing position, with each of the baskets operable to be attached relative to the basket support structure in the brewing position.

2. The drink brewer as claimed in claim 1,
said basket support structure including a first basket connector,
said baskets each including a side wall, with the side wall of at least one of the baskets presenting a second basket connector that is removably attachable to the first basket connector so that the at least one basket is removably attached to the basket support structure.

3. The drink brewer as claimed in claim 2,
said baskets each including a bottom wall that forms a bottom of the respective brew chamber,
said side walls each forming a side of the brew chamber, with the side walls defining an interior lateral dimension of the brew chamber.

4. The drink brewer as claimed in claim 3,
a first one of the baskets having an outer lateral dimension of the respective side wall that is smaller than the interior lateral dimension of a second one of the baskets, with the first basket being at least partly mounted within the brew chamber of the second basket.

5. The drink brewer as claimed in claim 4,
said first basket being mounted within the brew chamber and supported by the side wall of the second basket when the first basket is in the brewing position.

6. The drink brewer as claimed in claim 5,
said second basket including an annular basket lid that presents radially inner and outer connection margins,
said basket lid being removably attached to the side wall of the second basket by the outer connection margin and removably attached to the sidewall of the first basket by the inner connection margin to interconnect the first and second baskets.

7. The drink brewer as claimed in claim 6,
said side wall of the second basket presenting a second upper connection margin removably attached to the outer connection margin of the basket lid,
said attached outer and second upper connection margins comprising fractional-turn connectors that restrict relative axial movement between the second basket and the basket lid.

8. The drink brewer as claimed in claim 7,
said side wall of the first basket presenting a first upper connection margin removably attached to the inner connection margin of the basket lid,
said attached inner and first upper connection margins comprising fractional-turn connectors that restrict relative axial movement between the first basket and the basket lid.

9. The drink brewer as claimed in claim 5,
said bottom wall of each of the baskets presenting a drain opening that fluidly communicates with the brew chamber of the respective basket so that fluid can be drained from the brew chamber,
said second basket including a drain element shiftably mounted relative to the bottom wall and shiftable into and out of a closing position where the drain element prevents fluid flow through the drain opening.

10. The drink brewer as claimed in claim 9,
said drain element being shiftable downwardly out of the closing position to permit fluid flow through the drain opening,
said first basket engaging the drain element when mounted within the brew chamber in the brewing position, with the drain element shifted out of the closing position.

11. The drink brewer as claimed in claim 10,
said drain element comprising a drain plug that extends through the opening to present a plug end spaced above the bottom wall, with the bottom wall of the first basket engaging the plug end in the brewing position.

12. The drink brewer as claimed in claim 10,
said second basket including an annular basket lid that presents radially inner and outer connection margins,
said basket lid being removably attached to the side wall of the second basket by the outer connection margin and removably attached to the sidewall of the first basket by the inner connection margin to interconnect the first and second baskets.

13. The drink brewer as claimed in claim 12,
said second basket including a spring that urges the drain element toward the closing position so that the drain element is spring-biased into the closing position,
said side wall of the second basket presenting a second upper connection margin removably attached to the outer connection margin of the basket lid,
said attached outer and second upper connection margins comprising fractional-turn connectors that restrict relative axial movement between the second basket and the basket lid by the spring-biased drain element.

14. The drink brewer as claimed in claim 13,
said side wall of the first basket presenting a first upper connection margin removably attached to the inner connection margin of the basket lid,
said attached inner and first upper connection margins comprising fractional-turn connectors that restrict relative axial movement between the first basket and the basket lid by the spring-biased drain element.

15. The drink brewer as claimed in claim 1,
said nozzle being in the same position relative to the basket support structure when each of the baskets is mounted in the brewing position and the nozzle dispenses water.

16. The drink brewer as claimed in claim 15,
said nozzle being shiftably mounted relative to the basket support structure into and out of a dispensing position.

17. The drink brewer as claimed in claim 1,
each of said baskets including a wall that forms the respective brew chamber and presents a drain opening,
said drain opening of each basket fluidly communicating with the brew chamber of the respective basket so that fluid can be drained from the brew chamber.

18. The drink brewer as claimed in claim 17,
a first one of the baskets including a drain element shiftably mounted relative to the wall and shiftable into and out of a closing position where the drain element prevents fluid flow through the drain opening.

19. The drink brewer as claimed in claim 18,
said first basket being at least partly mounted within the brew chamber of a second one of the baskets.

20. The drink brewer as claimed in claim 19,
said drain element being shiftable downwardly out of the closing position to permit fluid flow through the drain opening,
said first basket engaging the drain element when mounted within the brew chamber in the brewing position, with the drain element shifted out of the closing position.

21. The drink brewer as claimed in claim 20,
said drain element comprising a drain plug that extends through the opening to present a plug end spaced above at least part of the wall, with the first basket engaging the plug end in the brewing position.

22. The drink brewer as claimed in claim 1,
a first one of the baskets including an annular basket lid that presents radially inner and outer connection margins,
said basket lid being removably attached to the side wall of the first basket by the outer connection margin.

23. The drink brewer as claimed in claim 22,
said basket lid being removably attached to the sidewall of a second one of the baskets by the inner connection margin to interconnect the first and second baskets.

24. The drink brewer as claimed in claim 22; and
a water distribution head that presents an inlet and a plurality of outlets,
said nozzle fluidly communicating with the inlet in the brewing position,
said brew chamber of the first basket fluidly communicating with the outlets, with water supplied by the nozzle being distributed by the outlets into the brew chamber of the first basket.

25. The drink brewer as claimed in claim 24,
said water distribution head removably attached to the inner connection margin of the basket lid.

26. The drink brewer as claimed in claim 23,
said side wall of the first basket presenting a first upper connection margin removably attached to the outer connection margin of the basket lid,
said attached outer and first upper connection margins comprising fractional-turn connectors that restrict relative axial movement between the first basket and the basket lid.

27. The drink brewer as claimed in claim 26,
said side wall of the second basket presenting a second upper connection margin removably attached to the inner connection margin of the basket lid,
said attached inner and second upper connection margins comprising fractional-turn connectors that restrict relative axial movement between the second basket and the basket lid.

28. The drink brewer as claimed in claim 1,
a pump in fluid communication with the nozzle and operable to pump water to the nozzle.

29. The drink brewer as claimed in claim 28,
a boiler in fluid communication with and operably connected between the pump and the nozzle.

30. A drink brewer operable to hold brewable grounds in either an open filter or an enclosed capsule and brew a drink using the grounds, said drink brewer comprising:
a water dispensing station that includes a water nozzle to dispense water onto the grounds; and
a brew basket structure presenting a brew chamber,
said brew basket structure being shiftable between an open filter brewing configuration where the brew basket structure supports the open filter with grounds during brewing and a capsule brewing configuration where the brew basket structure supports the enclosed capsule with grounds during brewing.

31. The drink brewer as claimed in claim 30,
said brew basket structure including multiple baskets each selectively locatable in a brewing position to provide the brew chamber, where the brew chamber is aligned so as to be in fluid communication with the nozzle to hold grounds adjacent the nozzle.

32. The drink brewer as claimed in claim 31,
said water dispensing station presenting a basket support structure that aligns and supports each of the baskets in the brewing position, with each of the baskets operable to be attached relative to the basket support structure in the brewing position.

33. The drink brewer as claimed in claim 32,
said basket support structure including a first basket connector,
said baskets each including a side wall, with the side wall of at least one of the baskets presenting a second basket connector that is removably attachable to the first basket connector so that the at least one basket is removably attached to the basket support structure.

34. The drink brewer as claimed in claim 33,
said side walls each forming an interior basket chamber that provides the brew chamber of the respective basket, with the side walls defining an interior lateral dimension of the basket chamber.

35. The drink brewer as claimed in claim 34,
a first one of the baskets having an outer lateral dimension of the respective side wall that is smaller than the interior lateral dimension of a second one of the baskets, with the first basket being at least partly mounted within the basket chamber of the second basket in the capsule brewing configuration.

36. The drink brewer as claimed in claim 35,
said first basket being mounted within the basket chamber and supported by the side wall of the second basket when the first basket is in the brewing position associated with the capsule brewing configuration.

37. The drink brewer as claimed in claim 35,
said first basket being removable from the basket chamber of the second basket so that the second basket is operable to hold grounds in the open filter brewing configuration.
